(19) United States
(12) Patent Application Publication
(10) Pub. No.: US 2008/0208970 A1
(43) Pub. Date: Aug. 28, 2008

(54) Systems and Methods for Enabling Selective Communications between Participants

(76) Inventor: Peter H. Krupp, Southlake, TX (US)

Correspondence Address: Giorgos A. Georgakis;Chowdhury & Georgakis, PC, PO BOX 90277, AUSTIN, TX, 78709-0277, US

(21) Appl. No.: 11/774,598

(22) Filed: Jul. 7, 2007

Related U.S. Application Data
(60) Provisional application No. 60/891,334, filed on Feb. 23, 2007.

(51) Int. Cl. G06F 15/16

(52) U.S. Cl. 709/204

(57) ABSTRACT

Systems and methods for selective communications, including: establishing a communication between one or more participants, where the communication is established according to configuration instructions, where the configuration instructions determine whether a one-way communication exists between one of the participants and another one of the participants.

### I. CROSS REFERENCE TO RELATED APPLICATIONS

This application claims priority to U.S. provisional application Ser. No. 60/891,334, filed on Feb. 23, 2007, the entire contents of which are hereby incorporated by reference herein for all purposes.

### II. BACKGROUND

The invention relates generally to the field of selective communications between one or more participants.

### III. SUMMARY

In one respect, disclosed is a method for selective communications, the method comprising: establishing a communication between one or more participants, wherein the communication is established according to configuration instructions, wherein the configuration instructions determine whether a one-way communication exists between one of the participants and another one of the participants.

In another respect, disclosed is a communications system comprising: one or more processors; one or more memory units; and one or more communication devices, the system being configured to: establish a communication between one or more participants, wherein the communication is established according to configuration instructions, wherein the configuration instructions determine whether a one-way communication exists between one of the participants and another one of the participants.

In yet another respect, disclosed is a computer program product stored on a computer operable medium, the computer program product comprising software code being effective to: establish a communication between one or more participants, wherein the communication is established according to configuration instructions, wherein the configuration instructions determine whether a one-way communication exists between one of the participants and another one of the participants.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram illustrating a system configured to enable a client to communicate with a host, in accordance with one embodiment.

FIG. 2 is a table containing information about a host, in accordance with one embodiment.

FIG. 3 is a block diagram illustrating a host configured to communicate with additional subhosts, in accordance with one embodiment.

FIG. 4 is a block diagram illustrating a client and a host communicating through an intermediary, in accordance with one embodiment.

FIG. 5 is a block diagram illustrating a host communicating simultaneously with multiple hosts, in accordance with one embodiment.

FIG. 6 is a block diagram illustrating a system configured to enable multiple participants to selectively participate with each other, in accordance with one embodiment.

FIG. 7 is a block diagram illustrating a system configured to enable a client to communicate with a host, in accordance with one embodiment.

FIG. 8 is a flow diagram illustrating a method for enabling the communication between a client and a host, in accordance with one embodiment.

FIG. 9 is a flow diagram illustrating a method for a client to issue commands to a host and to receive sensory information from the host and to determine whether intermediaries or additional subhosts are required, in accordance with one embodiment.

FIG. 10 is a flow diagram illustrating a method for enabling selective communications between one or more participants, in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

It should be noted that in the following discussion a user refers to either a client or a host.

//F1

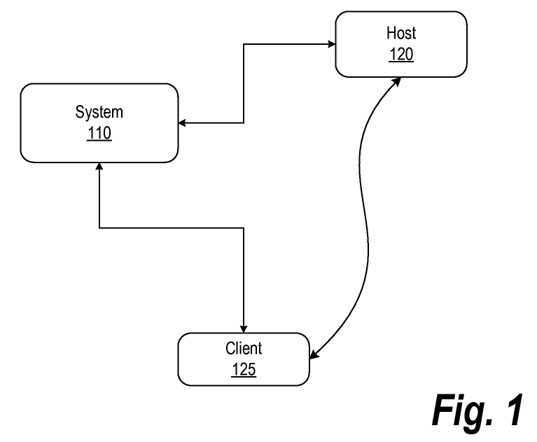

FIG. 1 is a block diagram illustrating a system configured to enable a client to communicate with a host, in accordance with one embodiment. In one embodiment, the communication enables client 125 to issue commands or instructions to host 120 and in response receive telepresence information from host 120.

In one embodiment, telepresence information can include anything that can be experienced by the host, such as sensory information (audio, video, etc.), perception, etc. Commands can include positioning, things to say, actions to take, etc. Communication may be accomplished by any means, including the internet, the cellular network, satellite communications, etc. Telepresence experiences generally may be used for real estate transactions/tours, live auctions, negotiations, explorations, news collection, etc.

In one embodiment, system 110 is configured to obtain from host 120 information on host attributes, and is also configured to obtain from client 125 desired attributes. In one embodiment, system 110 is further configured to enable a comparison of host attributes to desired attributes and in response to the comparison enable a communication between client 125 and host 120. Establishing a communication enables client 125 to issue commands/instructions to host 120 and to receive telepresence information from host 120.

In one embodiment, system 110 is configured to store the host attributes obtained by host 120 and the desired attributes obtained by client 125 in one or more memory locations. In one embodiment, the attributes may be organized in a directory of categories and subcategories to enable better searching and/or browsing of the attributes.

In one embodiment, client 125 may search/browse through existing entries of hosts in order to find the best matching host according to the telepresence experience desired by client 125. In another embodiment, host 120 may search/browse through existing “wish list” entries of clients in order to find a client desiring a telepresence experience that the host can provide. In both embodiments, a user may search through existing entries using a simple search, an advanced search, browse through the directory, or use a combination of the above methods. A “stumble upon” feature may also be used by the users to find relevant information.

In one embodiment, once communication is established between client 125 and host 120, client 125 may issue commands/instructions to host 120 and host 120 may receive the commands/instructions in multiple ways. For example, client 125 may issue commands using audio (speech, etc.), video, text, etc. In another embodiment, the client may issue commands using a game controller, a joystick, a computer keyboard, or a similar device. In other embodiments, personal portable devices may be used such as cell phones, PDAs, etc.

In another embodiment, the client and the host may use an intermediary, which can be a person, a machine, software, or a combination of all. An intermediary may be used, for example, to convert commands from one type to another. That is, the client may issue commands and the host may receive those commands using different methods. An intermediary may also be used, for example, to translate from one language to another.

In response to receiving commands/instructions from client 125, host 120 may then transmit telepresence information to client 125. The host may transmit sensory information, for example, such as video and audio as well as feel/touch, smell, and taste.

In addition to sensory type of information, host 120 may also transmit to client 125 the host's own perceptions and interpretations of the telepresence experience. Depending on the agreement between the host and the client, the host may provide the client with the host's own perceptions, especially when the host may be an expert in a particular field. For example, a host who is a tour guide may provide additional information to the client during a telepresence tour. A real estate agent may provide the client with their personal opinion of the state of a house, whether the sale price is fair, etc.

Many different types of technology may be used to capture the telepresence information. For example, the information may be captured using a simple camera and microphone for audio/visual information and a computer keyboard for entering text. In other embodiments, information may be captured through devices that are configured to sense taste, smell, and touch, for example. In yet other embodiments, telepresence information may be captured using brain sensors that can directly sense the experiences of the host. That is, the host's own sensory information may be sensed directly from the host's brain and may then be transmitted directly to a client's brain using appropriate instrumentation.

The telepresence information may be transmitted to the client in a variety of ways such as the internet, over a cellular network, via satellite, etc. Any available means may be used. In addition, the information may be recorded by the host and may be provided to the client at a later time. The information may be provided, on tape, disk, or other suitable media or the host may make the information available for download by the client through system 110 or otherwise. In an embodiment where the host is to record the telepresence experience, the client may provide the host with instructions in advance. The host may then execute and record the telepresence information in accordance with those instructions.

The client may also authorize the host to take some autonomy within certain guidelines set by the client, enabling the host to act independently, especially in non-live telepresence transmissions. In addition, the host can make certain autonomous decisions when, for example, live communication with the client is temporarily lost, enabling the host to continue the assignment instead of aborting it.

In one embodiment, the hosts may also make available pre-recorded telepresence experiences and provide information about these experiences to system 110. For example, hosts may sell pre-recorded tours of the Great Wall of China, pre-recorded hang gliding flights, pre-recorded real estate tours, etc. Users may then purchase and experience these without the need to set up their own live telepresence experiences.

Similarly, clients may post for sale telepresence experiences that the clients had previously made using one or more hosts, assuming the agreement between the client and the host allows for such resale.

The system can also provide rating systems for both clients and hosts in order to provide an incentive for both sides to obey their agreements and to encourage new users to participate by examining existing ratings for users.

The system may also provide the ability for users to set up parental controls in order to prevent minor users from accessing certain features and services of the system.

It should be noted that the host can be a person(s), a machine(s), or a combination of the two. Similarly, clients may be persons, groups, or companies.

//F2

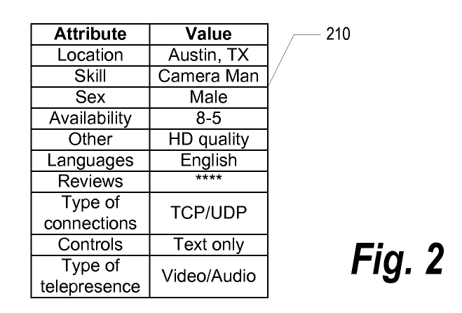

FIG. 2 is a table containing information about a host, in accordance with one embodiment. Table 210 shows one example of the type of information/attributes that may be provided by hosts or clients.

In one embodiment, the information may be obtained by hosts and stored in a memory location. As is shown in the example, the information may include location, skill set, sex, date and time availability, languages, types of connections accepted, languages spoken, previous reviews/evaluations, types of controls accepted, type of telepresence, other relevant information, etc. Such information may be used by clients in order to determine an appropriate host for the client's telepresence experience.

Similar information/attributes may be provided by clients as “wish list” type entries. That is, clients can provide and have stored similar attributes information and therefore enable hosts to search through the stored attributes to determine whether the hosts can provide the telepresence experience sought by the clients.

In one embodiment, the information from both clients and hosts may be organized in a directory under categories and subcategories so that a user can easily browse through the information. In addition, users may search through the information using simple or advanced type of searches or perform a combination of browsing and searching.

In one embodiment, attribute information from users may include multimedia (such as audio and video and other sensory information) in order to present the attributes more effectively. Users can create, for example, marketing-type pages in order to attract other users by better marketing themselves.

In one embodiment, the system may provide the means for hosts and clients to contact each other for additional information. For example, the users may contact each other using e-mail, instant messengers, telephones, etc.

//F3

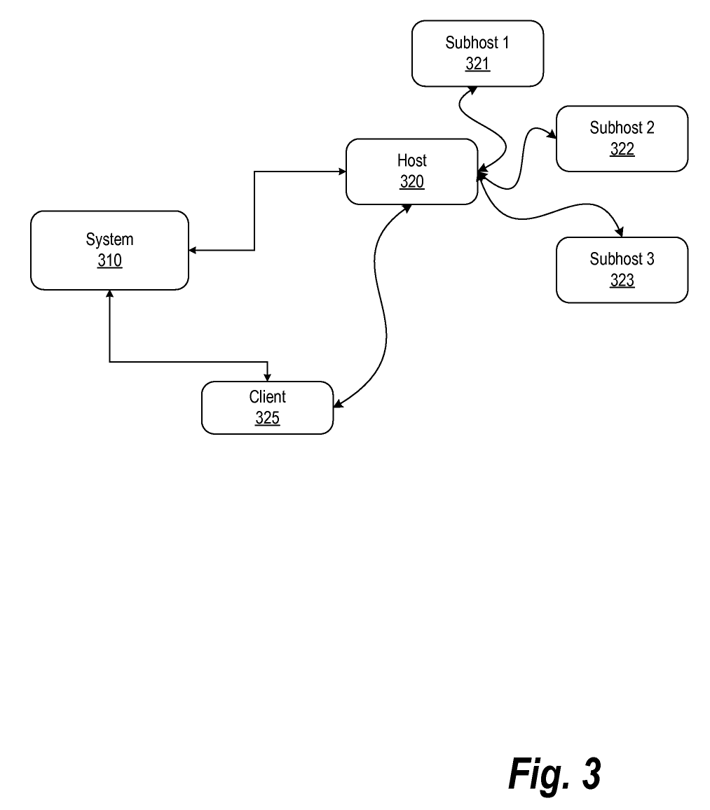

FIG. 3 is a block diagram illustrating a host configured to communicate with additional subhosts, in accordance with one embodiment. System 310 enables a communication between client 325 and host 320 for the purpose of client 325 issuing commands/instructions to host 320 and in response client 325 receiving telepresence information from host 320. In one embodiment, host 320 is configured to engage additional hosts (or subhosts) for the purpose of receiving, either directly or indirectly, a subset of the instructions issued by client 325 and providing a subset of the telepresence, either directly or indirectly, to client 325. Examples of such subhosts are subhost 321, subhost 322, and subhost 323.

In one embodiment, subhosts may be used in order to enhance the telepresence experience provided to the client. For example, multiple hosts may be used to provide the client with multiple views of a scene, to collect and provide information in various formats such as text, video, audio, etc. Hosts having different areas of expertise may also be combined, again in order to enhance the experience of the client.

Main host 320 may be set up to collect all the information and then transmit the information to client 325 or the subhosts may provide information directly to the client. A combination of the above methods may also be used.

//F4

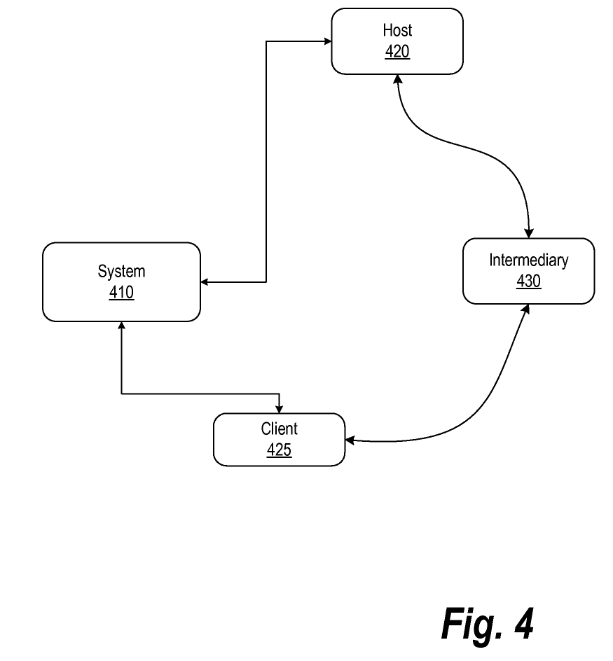

FIG. 4 is a block diagram illustrating a client and a host communicating through an intermediary, in accordance with one embodiment. System 410 enables a communication between client 425 and host 420 for the purpose of client 425 issuing commands/instructions to host 420 and in response client 425 receiving telepresence information from host 420. In one embodiment, client 425 may communicate with host 420 through intermediary 430. The intermediary may be used in converting commands issued by client 425, in converting telepresence information by host 420, or for both. Intermediary 430 may be a person, a machine, or a combination of the two.

For example, client 425 may be issuing commands by voice and intermediary 430 may translate those commands to text for host 420. Or client 425 may issue commands in text (by typing on a keyboard, for example), and those commands may be converted to voice by intermediary 430 for host 420. An intermediary may also be used in language translations, translating, for example, from English to Chinese and vice versa.

//F5

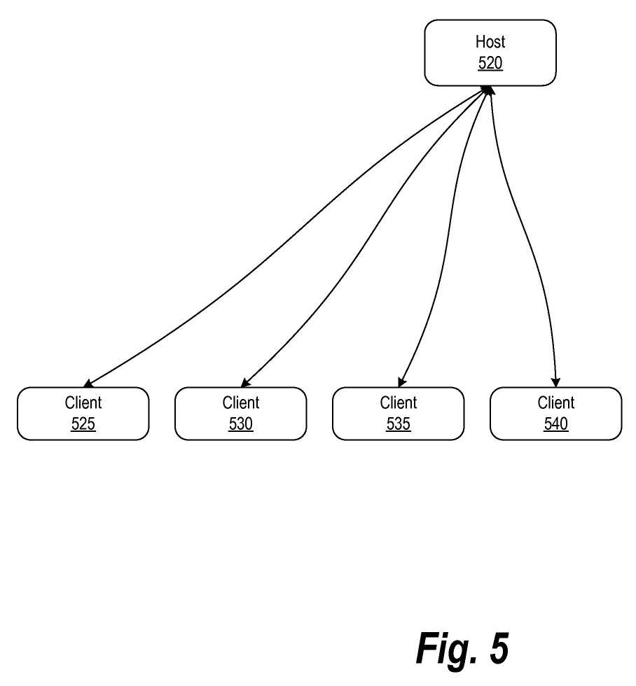

FIG. 5 is a block diagram illustrating a host communicating simultaneously with multiple hosts, in accordance with one embodiment. In the example shown in the figure, host 520 is configured to communicate with client 525, client 530, client 535, and client 540 simultaneously for the purpose of telepresence. In one embodiment, all the clients are configured to receive the same telepresence information from host 520. For example, all the clients may be attending the same concert, which is being provided by host 520. In one embodiment, one of the clients may be designated as master such that any commands/instructions issued from the master client override possibly conflicting commands by the other clients. In another embodiment, different clients may be designated to control different aspects of the telepresence experience. In yet another embodiment, a set of rules may exist to handle conflicts that may arise in the commands/instructions the different clients may provide.

//F6

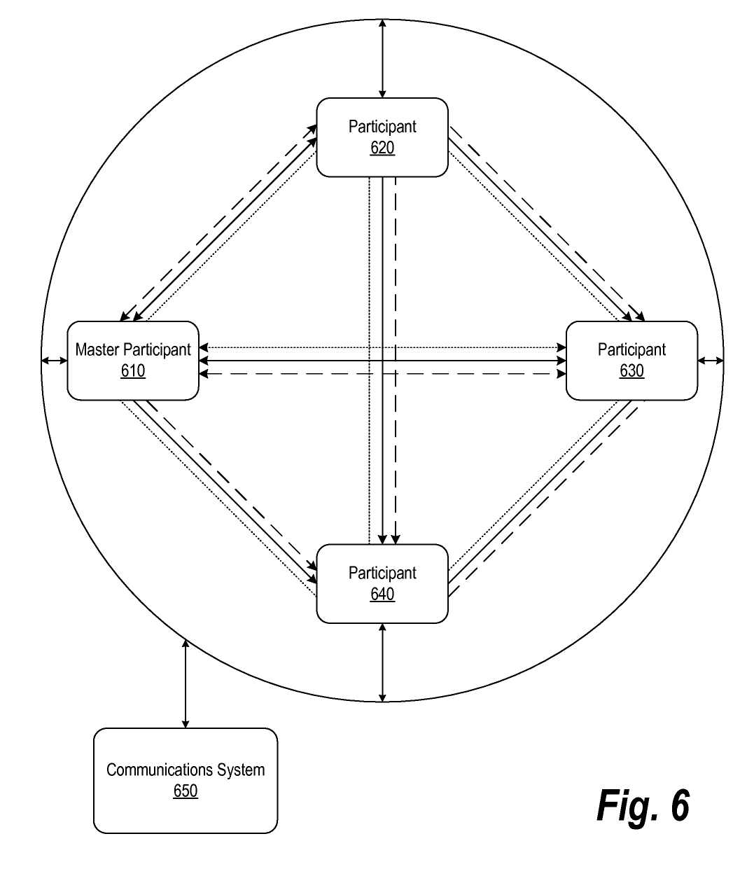

FIG. 6 is a block diagram illustrating a system configured to enable multiple participants to selectively participate with each other, in accordance with one embodiment.

In one embodiment, communications system 650 is configured to enable selective communications between one or more participants. In one embodiment, master participant 310 is designated as the participant who can set up configuration instructions, that may be stored by system 650, the configuration instructions determining the settings for the selective communications. Communications system 650 is configured to set up selective communications between each one of master participant 610, participant 620, participant 630, and participant 640 and each other one of the participants according to the configuration instructions.

In the example shown, the solid line may represent video communications, the dashed line may represent audio communications, and the dotted line may represent chat communications. Also in the example shown, master participant 610 may be a client requiring a real estate tour from host/participant 620, participant 630 may be the master participant's spouse, and participant 640 may be the master participant's real estate agent. The arrows indicate the direction in which a communication of a certain type has been enabled. That is, the system enables separately communications in each direction.

Through communications system 650 and by setting the configuration instructions, master participant 610 may determine who can communicate with whom for the purpose of the communications conference. For example, the master participant may enable a two-way video and audio communication between himself and the real estate tour host, participant 620, as is shown in the figure. On the other hand, master participant 610 may desire to limit other communications. For example, participant 630 and participant 640 may be able to receive audio and video from host/participant 620, but no video or audio may be transmitted to the host from either one of the participants. That is, those participants only monitor the communication. In addition, master participant 610 may set up separate chat communications with participant 630 and participant 640 for private chatting with those participants during the communication conference. That is, master participant 650 may desire to communicate with those participants privately without participant 620's knowledge.

In one embodiment, the master participants may also change the configuration instructions, thus changing the way the participants are communicating during the meeting. For example, master participant 610 may temporarily disable the transmission of video and audio to participant 620 in order to have a private audio and video communication with the other participants. In one embodiment, the master participant may accomplish this through the setup of macros, where each of the macros corresponds to a desired communication configuration.

In one embodiment, other types of communications may be implemented as well. In addition, the communications, such as the video, audio, and chat may be transmitted through traditional telephone lines, the internet, cellular networks, satellite networks, etc.

//F7

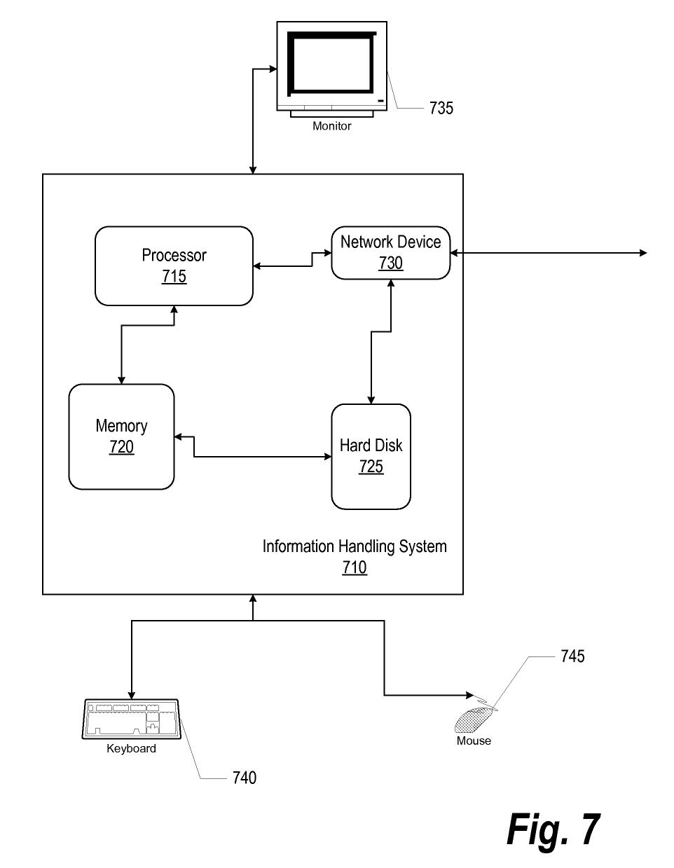

FIG. 7 is a block diagram illustrating a system configured to enable a client to communicate with a host, in accordance with one embodiment. Information handling system 710 may include software or hardware or both and is configured to perform the function(s) claimed in this application. In the example shown in the figure, the information handling system includes memory 720, processor 715, hard disk 725, input/output/network unit 730, keyboard 740, pointing device 745, and display monitor 735. Other configurations of the information handling system are possible.

It should also be noted that the system may be accessed over a network (such as the internet) through a browser (such as a web browser) either for updating data or monitoring purposes. A user need not have a particular application installed on the user's personal computer. Such a web-based system would be more easily accessible by more users.

//F8

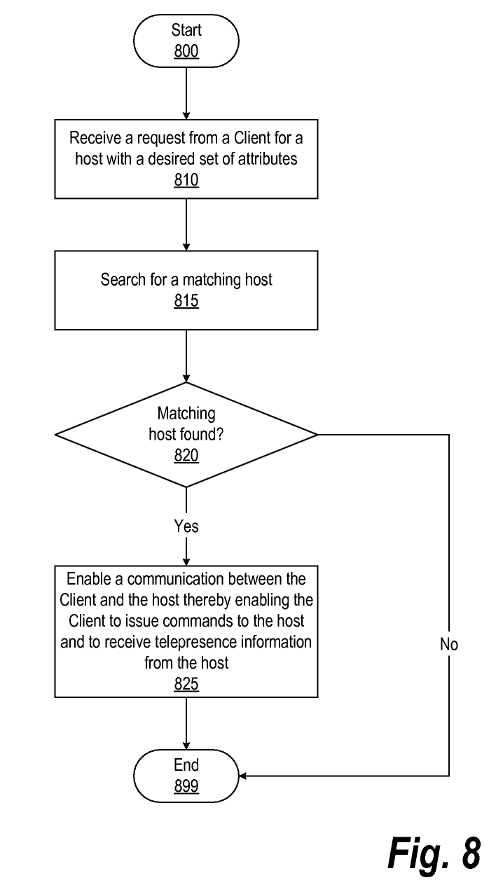

FIG. 8 is a flow diagram illustrating a method for enabling the communication between a client and a host, in accordance with one embodiment. Processing begins at 800 whereupon, at block 810, a request is received from a client desiring a host with a set of desired attributes, and at block 812, a search for a matching host is performed.

At decision 820, a determination is made as to whether a matching host is found. If a matching host is not found, decision 820 branches to the “no” branch whereupon processing ends at 899. In another embodiment, if the search does not yield an exact match, the closest matching host may be returned.

On the other hand, if a matching host is found, decision 820 branches to the “yes” branch, whereupon, at block 825, a communication is enabled between the client and the host, thereby enabling the client to issue commands/instructions to the host and the host to transmit telepresence information to the client.

//F9

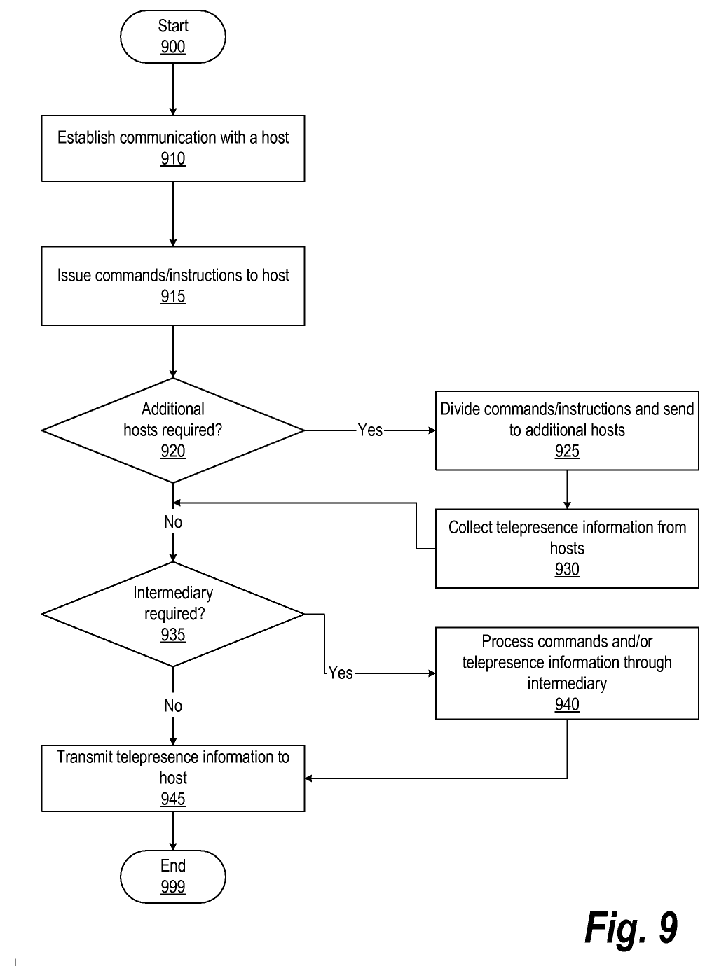

FIG. 9 is a flow diagram illustrating a method for a client to issue commands to a host and to receive sensory information from the host and to determine whether intermediaries or additional subhosts are required, in accordance with one embodiment. Processing begins at 900 whereupon, at block 910, communication is established with a host, and at block 915, commands/instructions are issued to the host in order to direct the host for the purpose of receiving telepresence information from the host.

At decision 920, a determination is made as to whether additional hosts are required for the telepresence experience. If additional hosts are required, decision 920 branches to the “yes” branch, whereupon, at block 925, the commands/instructions issued to the original host are divided and sent to additional hosts. At block 930, the telepresence information from the additional hosts is collected. Processing subsequently continues at block 935.

Returning to decision 920, if additional hosts are not required, decision 920 branches to the “no” branch, whereupon, at decision 935 another determination is made as to whether an intermediary is required. If an intermediary is required, decision 945 branches to the “yes” branch, whereupon, at block 940, client commands and/or host-provided telepresence information are processed/converted by the intermediary. Processing subsequently continues at 945.

Returning to decision 935, if an intermediary is not required, decision 935 branches to the “no” branch, whereupon, at block 945, telepresence information is transmitted to the client. Processing subsequently ends at 999.

//F10

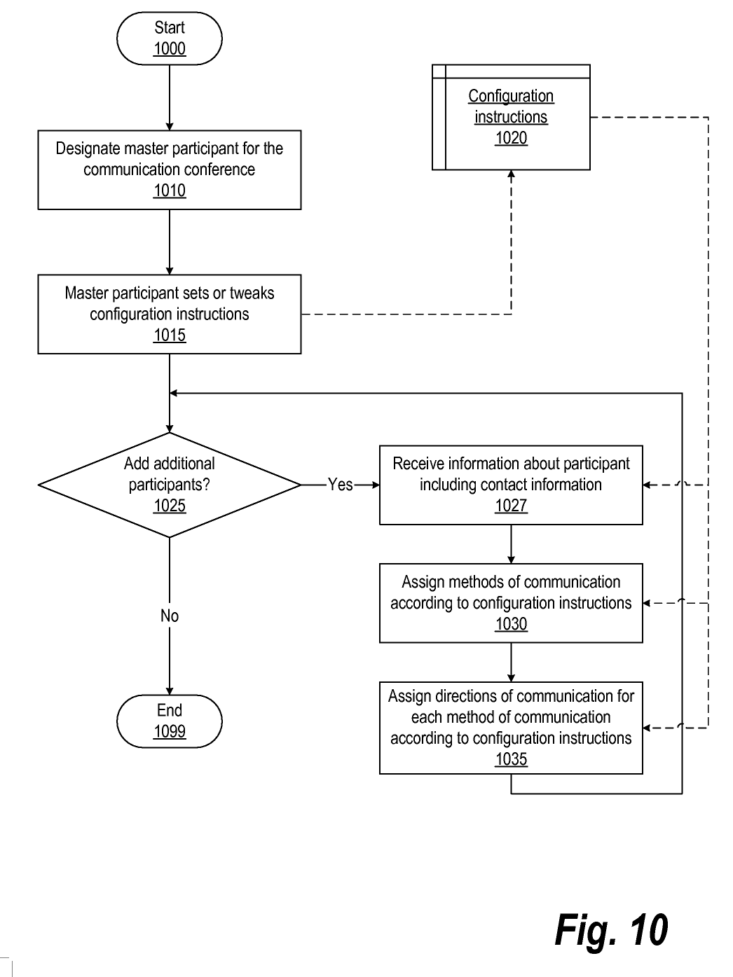

FIG. 10 is a flow diagram illustrating a method for enabling selective communications between one or more participants, in accordance with one embodiment.

Processing begins at 1000 whereupon, at block 1010, a master participant is designated. In one embodiment, a master participant may be the initial participant who logs into the system and requests a communication set up with other participants. In another embodiment, the master participant may also set up a proxy master participant to supervise the communication in place of the master participant.

At block 1015, the master participant may set or tweak configuration instructions 1020. In one embodiment, configuration instructions may include information about additional participants and whether communication in each direction may be established between each participant and each other participant. In another embodiment, the configuration instructions may also include information about which types of communication should be enabled between each participant and each other participant.

At decision 1025, a determination is made as to whether additional participants are to be added to the communication conference. If no more participants are to be added to the communication conference, decision 1025 branches to the “no” branch whereupon processing ends at 1099.

On the other hand, if an additional participant is to be added, decision 1025 branches to block 1027 whereupon information is received about the participant including contact information. At block 1030, methods of communication are assigned according to the configuration instructions. In one embodiment, communication methods can include video, audio (such as phone, cell phone, VoIP, etc.), chat, etc.

Processing subsequently returns to decision 1025 in order to determine whether additional participants are to be added to the communication conference.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for selective communications, the method comprising:
establishing a communication between one or more participants,
wherein the communication is established according to configuration instructions,
wherein the configuration instructions determine whether a one-way communication exists between one of the participants and another one of the participants.

2. The method of claim 1, wherein the participants are clients or hosts.

3. The method of claim 1, wherein the establishing the communication further comprises establishing the communication using one or more communication methods and wherein the configuration instructions further determine one or more methods of communication between one of the participants and another one of the participants.

4. The method of claim 1, further comprising designating a master participant, wherein the master participant is authorized to modify the configuration instructions.

5. The method of claim 4, further comprising adding additional participants at the request of the master participant.

6. The method of claim 4, further comprising designating a proxy master participant at the request of the master participant.

7. A communications system comprising:
one or more processors;
one or more memory units; and
one or more communication devices, the system being configured to:
establish a communication between one or more participants,
wherein the communication is established according to configuration instructions,
wherein the configuration instructions determine whether a one-way communication exists between one of the participants and another one of the participants.

8. The system of claim 7, wherein the participants are clients or hosts.

9. The system of claim 7, wherein the system is further configured to establish the communication using one or more communication methods and wherein the configuration instructions further determine one or more methods of communication between one of the participants and another one of the participants.

10. The system of claim 7, wherein the system is further configured to designate a master participant, wherein the master participant is authorized to modify the configuration instructions.

11. The system of claim 10, wherein the system is further configured to add additional participants at the request of the master participant.

12. The system of claim 10, wherein the system is further configured to designate a proxy master participant at the request of the master participant.

13. A computer program product stored on a computer operable medium, the computer program product comprising software code being effective to:
establish a communication between one or more participants,
wherein the communication is established according to configuration instructions,
wherein the configuration instructions determine whether a one-way communication exists between one of the participants and another one of the participants.

14. The product of claim 13, wherein the participants are clients or hosts.

15. The product of claim 13, wherein the code is further effective to establish the communication using one or more communication methods and wherein the configuration instructions further determine one or more methods of communication between one of the participants and another one of the participants.

16. The product of claim 13, further comprising designating a master participant, wherein the master participant is authorized to modify the configuration instructions.

17. The product of claim 16, further comprising adding additional participants at the request of the master participant.

18. The product of claim 16, further comprising designating a proxy master participant at the request of the master participant.
